(19) United States
(12) Patent Application Publication
(10) Pub. No.: US 2012/0003990 A1
(43) Pub. Date: Jan. 5, 2012

(54) MOBILE TERMINAL AND INFORMATION DISPLAY METHOD USING THE SAME

(75) Inventor: Min Ku LEE, Seoul (KR)

(73) Assignee: PANTECH CO., LTD., Seoul (KR)

(21) Appl. No.: 13/114,326

(22) Filed: May 24, 2011

(30) Foreign Application Priority Data
Jun. 30, 2010 (KR) 10-2010-0062788

(51) Int. Cl. H04W 4/02; G09G 5/00

(52) U.S. Cl. 455/456.1; 345/633

(57) ABSTRACT

A mobile terminal includes a communication unit to detect a first device and to receive device information from the first detected device; a memory unit to store a search classification; a control unit to determine class and location information of the first detected device using device information received from the first detected device, and to control a search result to be displayed on a display unit. An information display method using a mobile terminal includes detecting devices within a reference proximity, receiving device information from a first detected device; storing a search classification in the mobile terminal; determining class information and location information of the first detected device, and comparing the class information with the stored search classification; and displaying a determination result.

### CROSS-REFERENCE TO RELATED APPLICATION

This application claims priority from and the benefit under 35 U.S.C. §119(a) of Korean Patent Application No. 10-2010-0062788, filed on Jun. 30, 2010, which is incorporated by reference for all purposes as if fully set forth herein.

### BACKGROUND

1. Field

This disclosure relates to a mobile terminal and an information display method using the same, each capable of analyzing and displaying information of other device located within reference proximity of the mobile terminal, and controlling the selected device.

2. Discussion of the Background

Mobile terminals have been developed to provide various supplementary services, is such as services in gaming, message transmission/reception, Internet search, wireless information communications, electronic organizers, digital cameras, and video calls, as well as typical voice calls.

As Global Positioning System (GPS) is applied to mobile terminals, Assisted GPS (A-GPS) has been developed to assist the traditional GPS technology in various instances. More specifically, the A-GPS system allows reception of satellite information from a mobile communication network or a wireless Internet network using the assistance server in a case where a GPS terminal has a difficulty in searching for a satellite signal by itself in an area where satellite signal reception may be more difficult to be received, such as a downtown area in a metropolitan city.

### SUMMARY

Exemplary embodiments of the present invention provide an apparatus and a method for identifying other devices located in the vicinity of the mobile terminal, selecting the device to control, and controlling the selected device.

Additional features of the invention will be set forth in the description which follows, and in part will be apparent from the description, or may be learned by practice of the invention.

Exemplary embodiments of the present invention provide a mobile terminal including a communication unit to detect a first device and to receive device information from the first detected device; a memory unit to store a search classification; a control unit to determine class and location information of the first detected device using device information received from the first detected device, and to control a search result to be displayed on a display is unit.

Exemplary embodiments of the present invention provide an information display method using a mobile terminal including detecting devices within a reference proximity; receiving device information from a first detected device; storing a search classification in the mobile terminal; determining class information and location information of the first detected device, and comparing the class information with the stored search classification; and displaying a determination result.

Exemplary embodiments of the present invention provide a mobile terminal including a communication unit to detect a first device and to receive device information from the first device; a memory unit to store a search classification; a control unit to determine class information and location information of the first device using the device information, and to filter a search result based on the search classification; a display unit to display information processed by the mobile terminal and to receive user input, in which the user input includes a filter classification selection; and an interface unit to connect to the first device, and to communicate control commands to the first device.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, is illustrate embodiments of the invention, and together with the description serve to explain the principles of the invention.

FIG. 1 is a diagram of a configuration of a mobile terminal according to an exemplary embodiment of the invention.

FIG. 2 is a flowchart of an information display method using a mobile terminal according to an exemplary embodiment of the invention.

FIG. 3 is a diagram illustrating a communication process of a mobile terminal and a selected device according to an exemplary embodiment of the invention.

FIG. 4a and FIG. 4b are diagrams illustrating displaying of detected devices located within reference proximity of a mobile terminal according to an exemplary embodiment of the invention.

FIG. 5a and FIG. 5b are diagrams illustrating screens on a mobile terminal displaying selection of a detected device to control according to an exemplary embodiment of invention.

FIG. 6 is a diagram illustrating device information on a device received by a mobile terminal according to an exemplary embodiment of invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure will be thorough and complete, and will fully convey the scope of the is invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

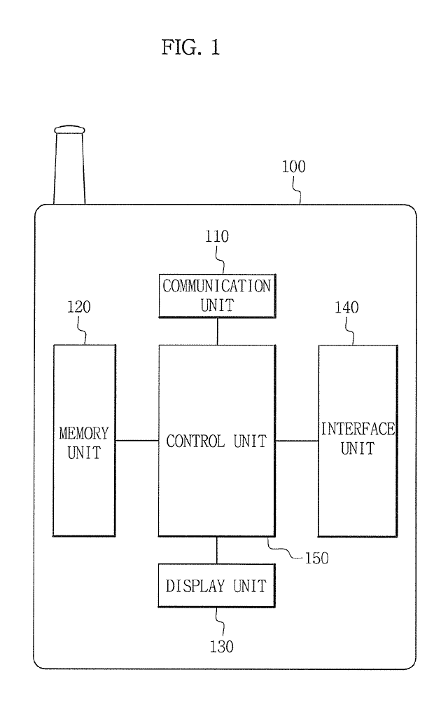

FIG. 1 is a diagram of a configuration of a mobile terminal according to an exemplary embodiment of the invention.

As shown in FIG. 1, a mobile terminal 100 includes a communication unit 110, a memory unit 120, a display unit 130, an interface unit 140, and a control unit 150.

The communication unit 110 performs a search to detect other devices located within a reference proximity to the mobile terminal 100. In addition, the communication unit 100 transmits and receives information to and from the detected devices. In an example, the communication unit 110 may include a location determination unit, a device searching unit to search for the other devices (“searching unit”), an information-on-other-devices receiving unit for receiving information on the other devices (“device information receiving unit”), and an information transmitting unit for transmitting information from the mobile terminal 100 to the other devices (“device information transmitting unit”). More specifically, the communication unit 110 may determine a location of the mobile terminal 100 through a GPS or the like, perform a search to detect the other devices at a reference distance based on the location of the mobile terminal 100, receive device information from the detected devices, and transmit command information from the mobile terminal 100 to the detected devices.

A search classification of various devices may be stored in the memory unit 120. In an example, search classification may include an upper class and a lower class according to type of the detected device. In an example, the upper class may be a general class, which may classify the detected device in a broad category corresponding to its characteristics. Accordingly, if the searched device is a coffee vending machine, the upper class may be a general classification of “vending machine.” The lower class may be a subset of the upper class, which may classify the detected device in a more detailed manner. In an example, if the upper class is identified as “vending machine,” the lower class may be classified as a “coffee vending machine,” “soda vending machine,” “snack vending machine,” or the like. Further, for a given detected device, an upper class may be provided without a lower class, or an upper class with is one or more lower classes.

The search classification may be used to filter the devices detected in the mobile terminal 100's initial search to display the device corresponding to a selected classification. More specifically, the user may select a classification of devices that the user would like to have displayed using the search classification stored in the memory unit 120 of the detected devices in order to display the device corresponding to the selected classification. Also, the search classification of the detected devices may be selected based the received device information, which may be displayed on the display unit 130. Further, the mobile terminal 100 may identify and display the classification information or classes of the detected devices using the information received on the detected devices.

In addition, the search classification stored in the memory unit 120 may also temporarily store information inputted and outputted through the mobile terminal 100.

The memory unit 120 may include a storage type media including flash memory, hard disk, MultiMediaCard (MMC) type memory, card type memory, random access memory (RAM), read-only memory (ROM), electrically erasable read-only memory (EEPROM), programmable read-only memory (PROM), magnetic memory, magnetic disk, and optical disk. In addition, the memory unit 120 may exist outside of the mobile terminal 100 at a server, which may be accessed via network.

The display unit 130 displays information processed by the mobile terminal 100. In an example, the display unit 130 may include a liquid crystal display (LCD), a thin film transistor-liquid crystal display (TFT-LCD), an organic light-emitting diode (OLED) display, a flexible display, and a 3D display. In addition, the display unit 130 may include a touch panel to receive an input from a user as well as to provide a display function.

The touch panel may receive an input signal by recognizing a pressure applied to a surface of the touch panel, or by detecting a change in capacitance, which may be generated into an electrical input signal. To provide a touch panel to receive a user input, a touch sensor in the form of a touch film, a touch sheet, or a touch pad may be employed. The touch sensor may detect a pressure during touching and a movement of an object after the touching, as well as a touch position and area. Further, a signal sensed by the touch sensor may be transmitted to a touch controller, and the sensed signal may be processed by the touch controller and then transmitted to the control unit 150 for information processing.

The interface unit 140 connects the mobile terminal 100 and the selected device to communicate. In an example, the interface unit 140 may include a device connecting unit.

The control unit 150 determines the class and the location information onof the detected devices corresponding to the initial search performed by the communication unit 110 and displays the determined information on the display unit 130. In an example, the determined classification information may be based on the received device information provided by the communication unit 110 and the stored search classification in memory unit 120. More specifically, the received device information may provide certain characteristic information, such as device identification number, which may be cross referenced with the stored search classification to identify the classification information of the detected device. In addition, the location information may be determined by the received information with respect to the current location information of the mobile device 100. Alternatively, the device information received by the mobile terminal 100 may include device identification number, location information, and classification information of the detected device. Accordingly, the memory unit 120 may stored the received information.

The control unit 150 may include an information analyzing unit, a device class checking unit, and a device location checking unit. The control unit 150 may analyze the received information on the detected devices, and control the class information of the detected devices to be displayed as supplementary information in an augmented reality. More specifically, the detected devices may be displayed at their identified location, which may be the same location in real life, in an augmented reality along with device information superimposed near the detected device image. Augmented reality may be displayed using the determined device information, such as class information and location information on the detected devices. Further, the determined class information may be displayed next to, or overlapping the displayed device in augmented reality.

The augmented reality refers to a type of virtual reality showing an image by combining an image of an object in a physical real world that a user sees with image of digitized information in a virtual world. Accordingly, in an augmented reality image, the user may see an image of a real object with virtual image of information relating to the object, which may be superimposed next to the image or overlapping the image. To display the class and location information on the detected devices in the augmented reality, an image of an object is first acquired using an image capturing device, such as a camera or the like included in a mobile terminal 100. Then, the class information and the location information processed by the mobile terminal 100 are matched with the acquired image so as to be displayed.

The information analyzing unit of the control unit 150 determines names of the detected devices, classes of the detected devices with respect to upper and lower classes, and location information on the detected devices including latitudes and longitudes of the detected devices. In an example, the class information of the detected devices may be determined using is the received device information and the search classification information stored in the memory unit 120. In an example, the class information of the detected devices may be defined as a device ID using a preset token, or as basic device information that may be stored as a packet in a profile format included in the information received from the detected devices. For example, the device ID may be defined as “vending machine;coffee;latitudexx;longitudeyy;altitudezz”, in a case where the preset token is a semicolon (;). The location information of the detected devices may be included in the information received from the detected devices, acquired through GPS tracking, or received as an input by the user.

In addition, in a state where the control unit 150 determines the location of the mobile terminal 100 through the GPS or the like, the control unit 150 may display a relative location to the detected devices by providing, distance information from the detected devices or directional information to the detected devices' location.

Also, the control unit 150 may control a selected device if the detected device is selected to be controlled. More specifically, the user may select a target device to control by selecting the target device from the detected devices that may be displayed from the initial search performed by the communication unit 110. In an example, the target device may be selected by the user or automatically based on a reference condition, such as the closest distance to the mobile terminal 100. Further, the selection of the target device may be performed from the initial search, where all of the detected devices within reference proximity may be displayed, or after the detected device are filtered according to a selected classification.

In addition, the control unit 150 may display a selection menu to control the selected device displayed in the augmented reality. More specifically, if the target device is selected to be controlled by the mobile terminal 100, the control unit 150 connects to the selected is device to enable communication between the mobile terminal 100 and the device. If the mobile terminal 100 and the selected device are connected, the control unit 150 may transmit a control command to the connected device. In an example, the control command may be transmitted by defining a user's request in a form of strings.

If authentication is requested by the selected device to make the connection, the control unit 150 may display an authentication screen at a request of the selected device. Accordingly, the mobile terminal 100 may connect to the device if the authentication is successfully achieved by the user.

In addition, if the control unit 150 is missing some information used to execute the control command, the control unit 150 may request and receive additional information from the connected device using a feedback function. For example, the stored location information of the detected device may have been changed since the mobile terminal 100 initially received its location information, so that updated information may be received to update the stored location information to allow control command to be properly executed. Alternatively, if the selected device was formerly a coffee vending machine, which was modified to a tea vending machine, updated information may be provided to appropriately control the selected device.

Also, as the received information, such as the location information or menu selection, of the selected device may change periodically after initially receiving its information, the mobile terminal 100 may also be set to receive the updated information on the specified device periodically through the communication unit 110. The frequency of updates may be specified by the user or be automated based on a reference condition.

In an example where coffee vending machines are searched for in a new area, the mobile terminal 100 may search for coffee vending machines within reference proximity and the is location information thereof, including the distances and direction information, from the location of the mobile terminal 100 may be calculated and displayed. In another example where the user wants to listen to music, audio jukeboxes within a short distance reference proximity may be searched for and the title of a desired music may be transmitted using the mobile terminal 100 to be played by the selected audio jukebox. In addition, if audio jukebox is selected to be controlled by the user, a list of music titles that can be played by the audio jukebox may be displayed for user selection. Other examples where mobile terminal 100 may be used to control other devices may include, mobile terminal 100 seeking heating or cooling systems located within reference proximity to control the temperature, and a mobile terminal 100 identifying operable devices located within reference proximity and making payment on an identified device to control the purchased device.

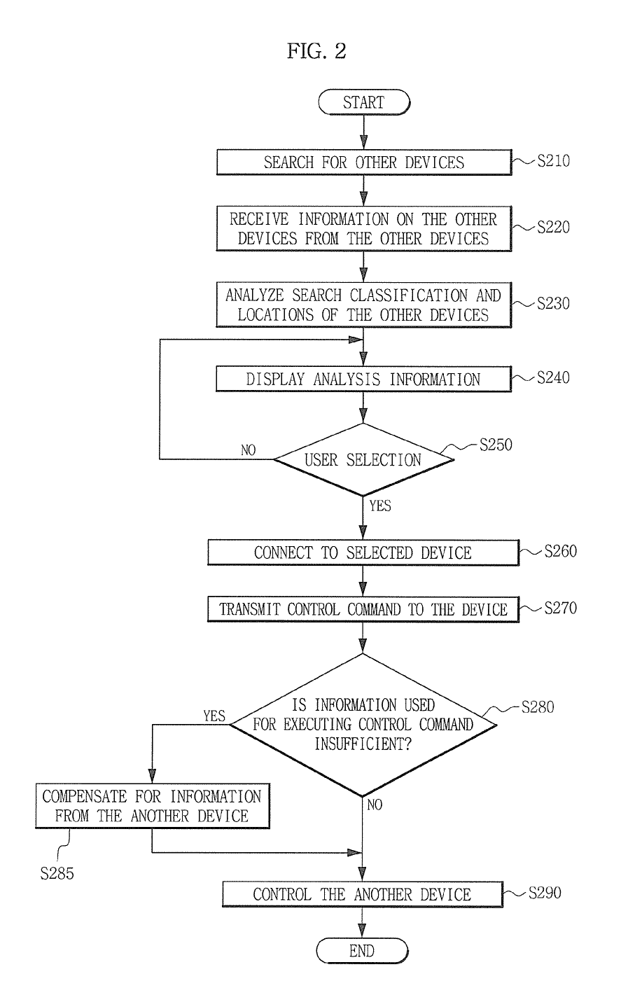

FIG. 2 is a flowchart of an information display method using the mobile terminal according to an exemplary embodiment of the invention.

Referring to FIG. 2, the mobile terminal performs a search for other devices, which may be located within reference proximity to the mobile terminal (S210). Next, the mobile terminal receives device information from the detected devices (S220). Analysis is made on the detected devices to determine classification and location information of the detected devices, using the received device information and stored search classification information (S230), and the analysis result is displayed on the display screen of the mobile terminal (S240). In an example, the mobile terminal may display the class information of the detected devices at their identified locations in an augmented reality. Accordingly, the class information and other supplementary information may be displayed as virtual data superimposed near to the detected device image.

If a signal to select a specific device from among the detected devices displayed is inputted by the user (S250), the mobile terminal connects to the selected device to enable communication between the mobile terminal and the selected device (S260) and transmits a control command to the connected device (S270). In an example, if authentication is requested to connect to the selected device, the mobile terminal may receive an authentication screen from the selected device and connects to the device if the authentication is successfully achieved by the user. Alternatively, if no user selection signal is received, the analysis result remains displayed on the display screen of the mobile terminal (S240).

Although not illustrated, the mobile terminal may automatically select a detected device based on reference conditions, such as closest distance, lowest cost, newest equipment, and the like.

If control command is received by the connected device but one or more information used to execute the control command is determined to be missing (S280), the mobile terminal requests and receives additional information from the connected device (S285). The received information is displayed and then used to transmit a control command to control the connected device (S290). In addition, the information on the once connected device may be updated periodically and transmitted to the mobile terminal, so that the mobile terminal may receive the updated information from the connected device periodically.

Alternatively, if control command received by the connected device is not missing any information to execute the control command, the mobile terminal executes the control command to control the connected device (S290).

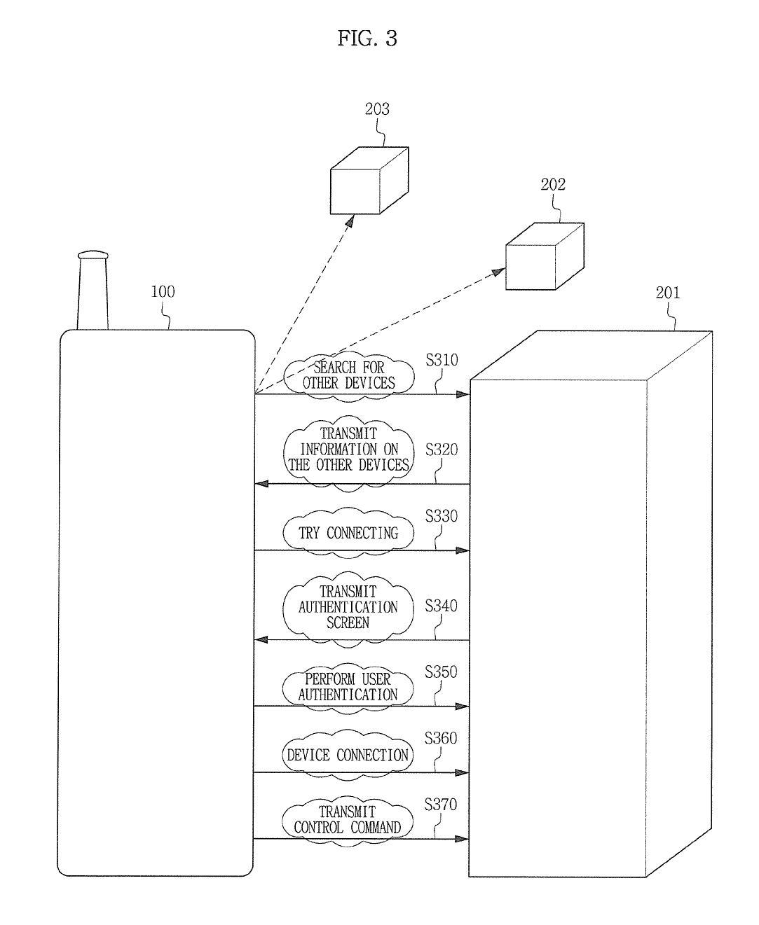

FIG. 3 is a diagram illustrating a communication process of a mobile terminal and a selected device according to an exemplary embodiment of the invention.

Referring to FIG. 3, if the mobile terminal 100 transmits a search signal to the other devices 201, 202, and 203 (S310), device 201 from among the other detected devices 201, 202, and 203 transmits its device information to the mobile terminal 100 in response to the search signal (S320). For the convenience of explanation, the communication between the device 201 and mobile terminal 100 is provided.

If the user selects the device 201 to control, the mobile terminal 100 tries connecting to the device 201 (S330). Next, in the case where authentication is requested by device 201 to connect, the device 201 transmits an authentication screen to the mobile terminal 100 requesting authenticating information (S340). Then, the authentication information inputted by the user is received by the mobile terminal 100 and transmitted to the device 201 to authenticate the mobile terminal 100 (S350). If the mobile terminal 100 is successfully authenticated, the mobile terminal 100 connects to the device 201 (S360). Thereafter, a control command is transmitted from the mobile terminal 100 to the connected device 201 (S370).

Alternatively, although not illustrated, if the mobile terminal 100 is able to connect to the device 201 without authentication, the mobile terminal 100 connects to the device 201 (S360), if request to connect is made by the mobile terminal 100 (S330). Next, mobile terminal 100 is connected to the device 201 and mobile terminal 100 is enabled to transmit control command (S370).

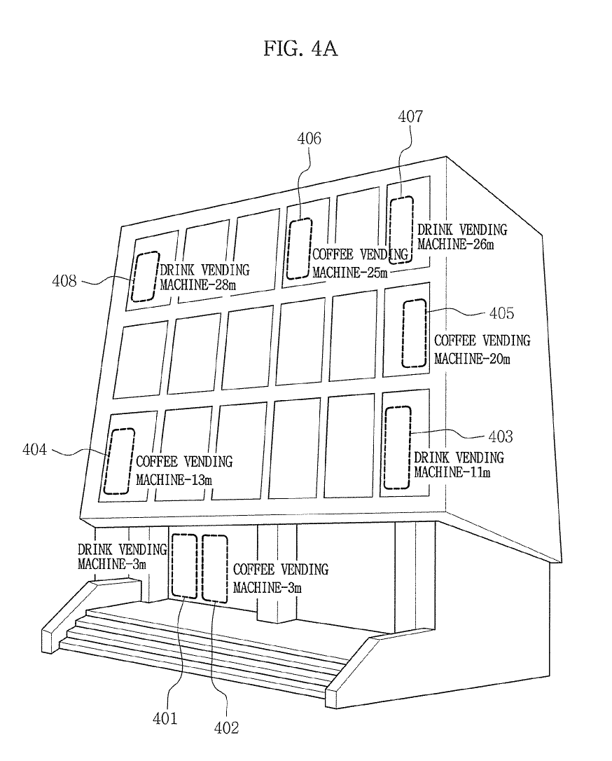

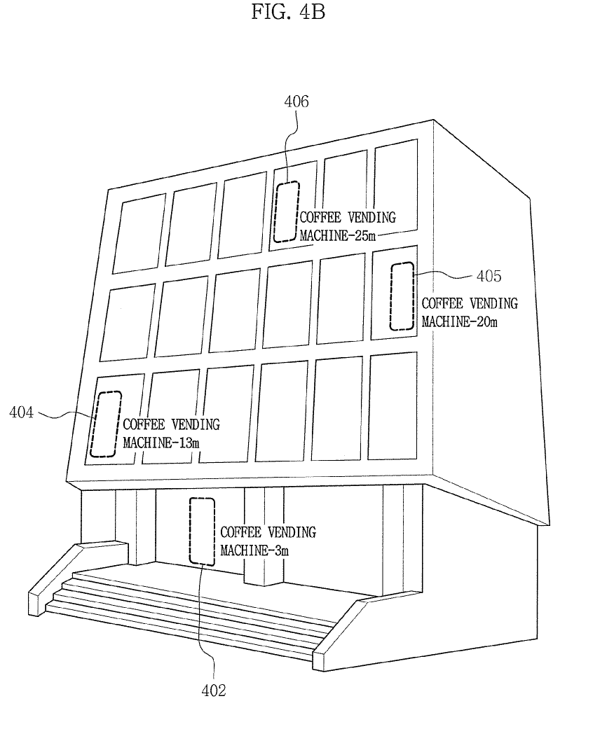

FIG. 4a and FIG. 4b are diagrams illustrating displaying of detected devices located within reference proximity of a mobile terminal according to an exemplary embodiment of the invention.

FIG. 4a is a diagram illustrating the display screen of the mobile terminal, which displays all of detected devices located within reference proximity to the mobile terminal location. FIG. 4b is a diagram illustrating the display screen of the mobile terminal, which displays the detected devices corresponding to the selected classification inputted by the user.

Referring to FIG. 4a, as a result of searching for vending machines located within a reference proximity to the mobile terminal, four drink vending machines 401, 403, 407, and 408 and four coffee vending machines 402, 404, 405, and 406 are detected and displayed on the mobile terminal. In an example, the mobile terminal may determine the location information of the mobile terminal using a GPS technology or similar technologies and calculate and display distances to the detected devices from the location of the mobile terminal. In addition, the detected drink vending machines and coffee vending machines may be displayed on the mobile terminal in augmented reality. More specifically, the detected vending machines may be displayed at their identified locations with supplemental descriptive information that may be shown as a virtual image located near to the image of the detected vending machines.

Referring to FIG. 4b, a selection is made to search for coffee vending machine class from a list of available classes detected by the mobile terminal, which in this case is drink vending machine class and coffee vending machine class as illustrated in FIG. 4a. As a result, the mobile terminal may display the four coffee vending machines 402, 404, 405, and 406, excluding the drink vending machines, in response to the selection signal.

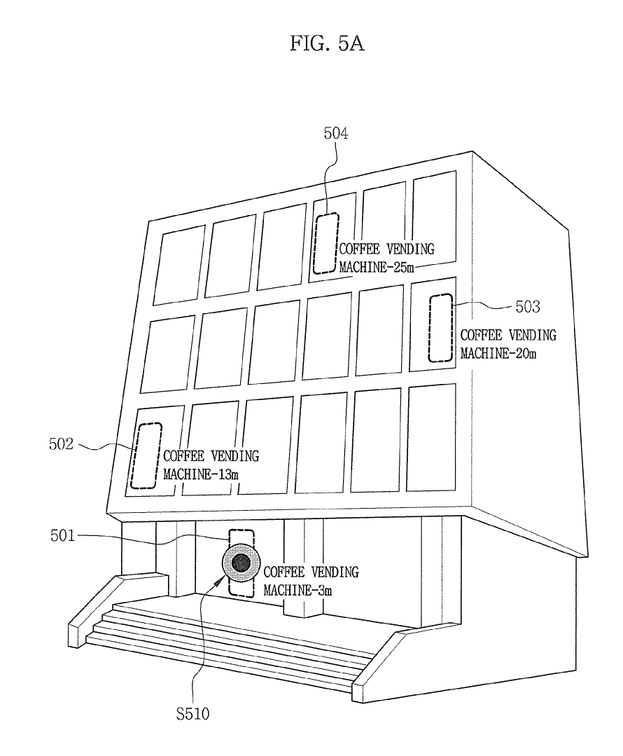

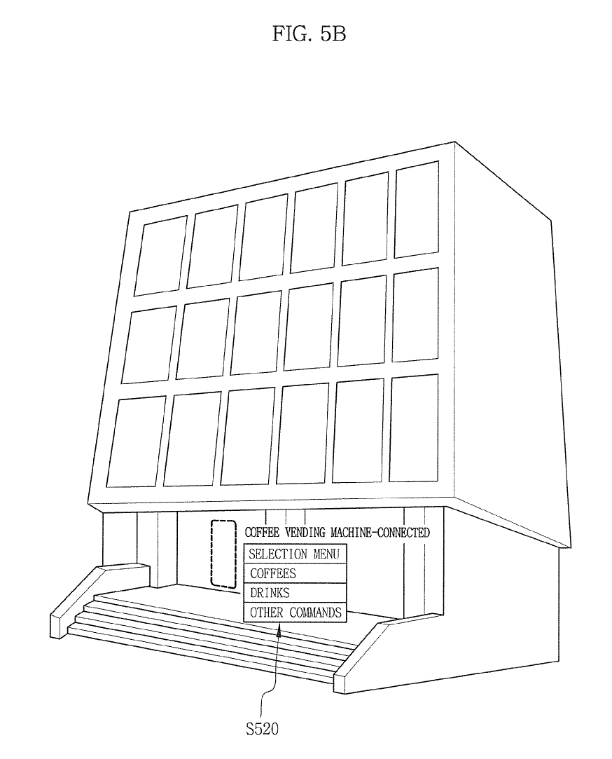

FIG. 5a and FIG. 5b are diagrams illustrating user provided screens on a mobile terminal displaying select of a detected device to control according to an exemplary embodiment of invention.

FIG. 5a is a diagram illustrating the display screen of the mobile terminal which displays the devices filtered by the mobile terminal in accordance to the steps illustrated in FIG. 4a and FIG. 4b, along with the selected device 501 to connect and control. FIG. 5b is a diagram is illustrating the display screen used to control the selected device if a connection between the mobile terminal and the selected device is achieved.

Referring to FIG. 5a, a selection signal to select a coffee vending machine 501 is inputted by the user on the display screen that displays the coffee vending machines 501, 502, 503, and 504 (S510). If the selection signal is inputted, the mobile terminal connects to the selected coffee vending machine 501. Referring to FIG. 5b, after the mobile terminal and the coffee vending machine 501 are connected to each other, a selection menu for controlling the coffee vending machine is displayed (S520). The selection menu may show kinds of drinks that can be selected from the coffee vending machine, and the user may input a control command via text.

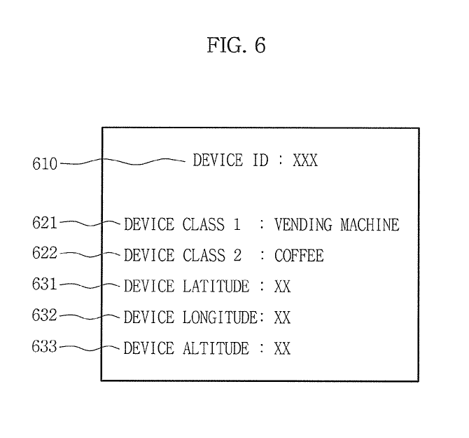

FIG. 6 is a diagram illustrating device information on a device received by a mobile terminal according to an exemplary embodiment of invention.

Referring to FIG. 6, device information on a detected device that a mobile terminal receives includes basic device information in a profile format. More specifically, the basic device information is defined as a packet, and may include a device ID 610, a device class 1 610 as a general classification of the device, a device class 2 622 as a sub-classification of device class 1 610, and device location information. In an example, device location information may include a device latitude 631, a device longitude 632, and a device altitude 633.

The mobile terminal and the information display method using the mobile terminal according to the disclosure may provide class and location information on the detected devices within reference proximity from the mobile terminal location. Further, the detected device may be selected to be connected, and to be controlled.

It will be apparent to those skilled in the art that various modifications and is variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a communication unit to detect a first device and to receive device information from the first detected device;
a memory unit to store a search classification;
a control unit to determine class and location information of the first detected device using device information received from the first detected device, and to control a search result to be displayed on a display unit.

2. The mobile terminal according to claim 1, wherein the control unit controls the first detected device be displayed based on a selected class, wherein selection of the class filters out the first detected device corresponding to the selected class to be displayed in an augmented reality at the first detected device's location with class information and location information.

3. The mobile terminal according to claim 2, wherein the control unit controls relative locations of the first detected device and a second detected device to be displayed with respect to a location of the mobile terminal in the augmented reality, wherein relative location is a distance of the first detected device to the mobile terminal or a direction of the first detected device from the mobile terminal.

4. The mobile terminal according to claim 1, wherein the display unit receives a user input comprising a selection of the first detected device, a selection of classification type, or a user command.

5. The mobile terminal according to claim 1, further comprising an interface unit to connect to a second detected device,
wherein the control unit connects to the second detected device according to a selection by the user via the interface unit, and transmits a control command to the second detected device.

6. The mobile terminal according to claim 4, wherein the control unit displays a selection menu to control the second detected device in the augmented reality.

7. The mobile terminal according to claim 5, wherein the control unit displays an authentication screen if authentication is requested by the second detected device, and connects to the second detected device if the authentication is successfully achieved.

8. The mobile terminal according to claim 5, wherein the control unit requests additional information via the communication unit if a control command to control the second detected device is missing one or more information of the second detected device, and provides the additional information received in response to the additional information request to the user.

9. The mobile terminal according to claim 1, wherein the information received from the first detected device comprises location information of the first detected device, or location information of the first detected device is acquired through GPS tracking.

10. The mobile terminal according to claim 1, wherein the communication unit receives updated information from the first detected device after receiving the device information from the first detected device.

11. The mobile terminal according to claim 1, wherein the device information of the first detected device is defined as a device ID using a preset token, or defined as basic device information in a profile format.

12. The mobile terminal according to claim 1, wherein the communication unit searches for the first device to detect.

13. An information display method using a mobile terminal, comprising:
detecting devices within a reference proximity;
receiving device information from a first detected device;
storing a search classification in the mobile terminal;
determining class information and location information of the first detected device, and comparing the class information with the stored search classification; and
displaying a determination result.

14. The information display method according to claim 13, wherein displaying the determination result further comprises displaying class information of the first detected device at its identified location in an augmented reality.

15. The information display method according to claim 14, wherein displaying in the augmented reality further comprises:
receiving selection input of a second detected device by a user;
connecting to the second detected device; and
transmitting a control command to the second detected device.

16. The information display method according to claim 15,
wherein connecting to the second detected device further comprises displaying an authentication screen on the mobile terminal if a request is received to connect the second detected device with the mobile terminal, and
the connection to the second detected device is performed if the authentication is successfully achieved.

17. The information display method according to claim 15, wherein transmitting the control command to the second detected device further comprises:
requesting additional information from the second detected device; and
displaying the additional information.

18. The information display method according to claim 13, wherein receiving device information on the first detected devices comprises:
receiving updated device information from the first detected device at a reference periods.

19. A mobile terminal, comprising:
a communication unit to detect a first device and to receive device information from the first device;
a memory unit to store a search classification;
a control unit to determine class information and location information of the first device using the device information, and to filter a search result based on the search classification;
a display unit to display information processed by the mobile terminal and to receive user input, wherein the user input comprises a filter classification selection; and
an interface unit to connect to the first device, and to communicate control commands to the first device.
